(19) United States
(12) Patent Application Publication
(10) Pub. No.: US 2020/0103530 A1
(43) Pub. Date: Apr. 2, 2020

(54) METHOD FOR EXTRACTING ELEVATION CONTROL POINT WITH ASSISTANCE OF SATELLITE LASER ALTIMETRY DATA

(71) Applicant: Chinese Academy of Surveying and Mapping, Beijing (CN)

(72) Inventors: Chunquan Cheng, Beijing (CN); Zhiquan Zuo, Beijing (CN); Guoman Huang, Beijing (CN); Jixian Zhang, Beijing (CN); Li Zhang, Beijing (CN); Hanjiang Wen, Beijing (CN)

(21) Appl. No.: 16/702,503

(22) Filed: Dec. 3, 2019

Related U.S. Application Data
(63) Continuation of application No. PCT/CN2018/089914, filed on Jun. 5, 2018.

(30) Foreign Application Priority Data
Jun. 5, 2017 (CN) 201710413046

(51) Int. Cl. G01S 17/894; G01S 17/90; G01S 7/48

(52) U.S. Cl. CPC G01S 17/894; G01S 7/4808; G01S 17/90

(57) ABSTRACT

A method of elevation control points extraction assisted by satellite laser altimeter data, which is characterized in that take the waveforms received by satellite and the waveforms simulated from digital surface model (DSM) of image scene reconstruction as input data, and includes two times of waveform matching and combined process of multi-source remote sensing data. The elevation control points could be extracted without the influence of terrain fluctuation or urban buildings for the terrain information of laser spot area has been taken into account. The first time is realized by matching two groups of waveforms from the received and the simulated, and the spatial registrations between locations of laser spots and DSM are realized. The second time is realized by matching two single waveforms from the received and the simulated, and local system errors in DSM of laser spot area could be extracted. With the registration results and local system errors, many applications including extraction of elevation control points could be easily developed. The invention mainly includes the following steps: (1) Preliminary refinement of orientation parameters of high-resolution stereo or InSAR images by free net adjustment; (2) DSM reconstruction with high-resolution stereo images or InSAR data; (3) dividing the received laser altimetry data into groups; (4) Waveform extraction of the receiving group; (5) observation design for simulation waveform group; (6) simulation waveform acquisition through observation of DSM; (7) matching the received group waveforms with the simulated group waveforms; (8) plane position registration between laser spot and DSM; (9) matching each pair of waveforms in group between the received and the simulated respectively; (10) extraction of DSM elevation system errors on each laser spot area; (11) extraction of image elevation control points; (12) refinement of DSM elevation, calibration of satellite laser altimeter sensor, combined processing with laser altimetry and image remote sensing. The invention mainly solves two difficulties. One difficulty is finding footprints, or say laser spot areas, of satellite laser altimeters on stereoscopic images, InSAR images and the DSM they generate. Another difficulty is the accurate elevation extraction of laser spot areas with uneven terrain. The invention can realize the spatial registration between laser spot and DSM or remote sensing in different terrain and establish spatial connection between laser altimetry data and stereo images or InSAR data. In different terrain conditions, by the invention, the satellite laser altimetry data can be used for high-precision elevation control of 3D reconstruction/positioning of stereo images or InSAR data.

### RELATED APPLICATION(S)

This application is a continuation of International Application No. PCT/CN2018/089914, which designated the United States and was filed on Jun. 5, 2018, published in Chinese, which claims priority under 35 U.S.C. § 119 or 365 to Chinese Application No. 201710413046, filed on Jun. 5, 2017. The entire teachings of the above applications are incorporated herein by reference.

### FIELD OF THE INVENTION

The invention relates to high-resolution photogrammetry and remote sensing, data matching and registration, and multi-source remote sensing data joint processing and other fields. The invention focuses on the spatial matching and registration methods of laser altimetry data and DSM and image data.

### BACKGROUND OF THE INVENTION

The research on satellite radar altimetry technology is mainly concentrated in some developed countries such as the United States and Europe, while in other countries, the development of the technology in developing countries is relatively lagging especially. At present, more than 10 satellite altimetry plans had been implemented in the world. In 2003, the United States launched the laser altimetry satellite ICESat-1, which equipped with the Geoscience Laser Altimeter System (GLAS), the orbital height is 590 km. The ICESat-2, which is scheduled for launch in 2017, is equipped with an advanced topographic laser altimeter system (ATLAS), which uses a micropulse multi-beam (3×2 structure of 6-beam laser) photon counting lidar technology to overcome the problem of GLAS fast energy consumption, and the footprint is 10 m and the measurement accuracy is 10 cm. The LIST, which is scheduled for launch in 2020, scans the earth with an array detector at 5 m resolution and 10 cm accuracy, and its technology indicates that future laser altimetry systems will evolve toward high repetition, multi-beam, scanning and single-photon modes. Currently, Chinese satellites with altimeter sensors include HY-2A and ZY-3. GF-7 is scheduled for launch in 2018, which is specially developed for optical image stereo mapping. The representative laser altimetry satellites at home and abroad are shown in Table 1.

The initial task of satellite laser altimetry is aimed at obtaining sea surface shape, studying ocean circulation and other oceanographic parameters. The application of satellite altimetry data also expanded from the change of single points to the study of change monitoring on the entire surface gradually, and it also has been widely used in oceanography, geodesy and geophysics. The observational measurements obtained by satellite altimetry are used as boundary conditions to establish an ocean dynamic model, and the depth of the ocean is calculated to map the topography and landform of the seabed. The geometric positioning of the laser altimetry radar target is generally use rigorous model, which is constructed by the spatial vector of the laser beam determined by the orbital attitude information of the satellite. The improvement of satellite altimetry accuracy mainly depended on the improvement of altimeter sensor and data processing algorithms such as waveform reconstruction. The received signal pulse of the laser altimetry system can be regarded as the response function of the transmitted pulse convolution target. The intensity and peak value of the echo pulse energy will change caused by the surface reflectivity. The differences of target composition and topography in the ground spot will affect the change of echo waveform of surface structure and the flight time of the laser pulse, which leads to the fission or broadening of the waveform of the echo pulse. There is a close relationship between the waveform and the feature of the ground feature.

TABLE. 1
Representative laser altimetry satellites

| | | | Elevation | Footprint |
|---|---|---|---|---|
| Name | Country | Launch time | accuracy (cm) | (km) |
| Jason-1, 2, 3 | France/US | 2001, 2008, 2016 | 4.2, 2.5-3.4 | 2.2/2.2 |
| ENCISat | EU | 2002 | 2.5 | 1.7 |
| ICESat-1 | US | 2003 | 15 | 0.07 |
| CryoSat-1, 2 | EU | 2005, 2010 | 1-3 | 1.6 |
| HY-2A | China | 2011 | 4 | 2 |
| ZY3-02 | China | 2016 | 573 | 0.05 |

In theory, geometric positioning of spot center can extract the spot position and elevation information from the laser altimetry data. However, the laser spot positioning plane error and the laser spot diameter is usually large. It is difficult to extract the elevation of a specific point in complex terrain from the laser altimetry data. At the same time, the spot distribution is sparse and uneven, so the laser altimetry data is difficult to use directly for large-scale terrain acquisition currently.

In recent years, it has gradually gained attention in processing of optical and SAR image due to the high precision of laser altimetry. For example, the ICESat/GLAS data is used to the elevation control in the ASTER DEM data production, and the laser spot dense area is directly integrated into the DEM; and the ICESat/GLAS is used to correct the InSAR elevation and obtain high-precision Antarctic DEM. Aiming at the difficulty that the positioning accuracy, especially elevation accuracy of Chinese high-resolution remote sensing satellites under completely uncontrolled conditions cannot satisfy large-scale mapping, an algorithm is proposed to select elevation control points based on multi-criteria constraint, which use the filtered flat ground laser footprint data as remote sensing image elevation control. The existing literature tested the image positioning to the laser elevation control of ZY-3, which showed that the accuracy of 1:50000 can be achieved under uncontrolled conditions. Some relevant scholars proposed some ideas for laser ranging data to assist two-line array image processing, the simulation results of the laser ranging data and the two-line image beam method show that the deformation of the route model system can be effectively improved. Extracting the elevation of high-resolution image point from the large spot laser altimetry data on different terrain images is still rarely covered in the literature currently.

Due to the error of image target, laser remote sensing target localization and the differences in remote sensing mechanisms, there is no effective method to achieve strict registration for the relative spatial relationship between them. At the same time, the laser altimetry data is a comprehensive response of the spot area target. The elevation control point information required by the remote sensing image includes the image point coordinates and its corresponding elevation. There is a lack of a robust and effective method to extract elevation information of image points from in laser altimetry data with high accuracy. The lack of spatial connection between laser altimetry data and optical data and SAR data has seriously restricted the application of laser altimetry data in space photogrammetry. Laser altimetry data assisted in accurately extracting elevation information of an image point or feature point is very important to the development of satellite photogrammetry, it also contains huge economic benefits.

### SUMMARY OF THE INVENTION

### The Invention Contents

The invention realized according to the following principles and findings:

The geometric errors of satellite remote sensing or their products within a period of time and a certain range mainly presents systematic characteristics. Using this characteristics, the received laser altimetry data on a track of one orbit is taken as a reference group, and the actual locations of laser spots on DSM are searched with same offset to the theoretical locations of the group laser spots. Different offsets constitute different simulation groups. Find the actual positions of the spots on DSM by investigating the matching values of the received group and the simulated groups.

Firstly, the spatial registration between laser spot and DSM as well as the DSM elevation system errors of spot area are extracted by two times of matching, and then the extraction of elevation control points and other applications are realized.

Taking the received group waveforms as the reference template, could get different matching effects when the waveforms simulated with different DSM:

1) When there are no errors in the positions of simulation laser spots on DSM, the position and shape of the simulated group waveforms are consistent with the received group waveforms in theory, as shown in FIG. 1(a);

2) When the locations of the simulation laser spots on DSM only have elevation direction system errors, the overall moving of reference group waveforms along the time axis can get the optimal match between the simulation group and received group, as shown in FIG. 1(b).

3) When there is a spot position offset between the simulation group and the received group, that means the DSM elevation may be increase, decrease, or unchanged as a whole. Correspondingly the simulation waveform center will shift left, shift right, or unchanged along the time axis. The waveform shape will also change when the terrain in spot area changes. The offsets and the changes would result in a significant decrease in the group matching effects, as shown in FIG. 1(c).

The principle of registration between laser spot locations and DSM is to find the simulation group that is optimally matched with the received group. That is, take the received group waveforms as a whole, take the theoretical locations of each received group spots as searching center, obtain a series of waveform groups through simulation by observing DSM objects around searching center, the laser spot locations of the optimally matched group could be considered as the actual positions of the received laser spots on DSM, as shown in FIG. 2.

In the case of knowing the actual spot position on DSM, the DSM elevation system errors of the spot area can be obtained by the difference of return time between simulation waveform and received waveform measured through matching.

Many applications could be realized with the registration results and local system errors of DSM. Extraction of elevation control points of remote sensing images is one of the applications, have significant difference from other methods that can suitable for uneven terrain and urban area.

### DESCRIPTION OF THE INVENTION

The registration between location of observed object of laser altimetry and DSM is realized by matching with group waveforms as a whole. That is, take a section of orbit laser altimetry waveforms as a whole, and convert the registration between locations of observed object of laser altimetry and DSM into matching of received group waveforms and group waveforms simulated with DSM. Then convert elevation system error calculation of each local DSM of the spot area into the matching of the received waveform and the simulated waveforms. The core process of the invention consists of two times of waveform matching and can be extended to the following steps:

Step 1. Preliminary refinement of orientation parameters of high-resolution stereo images or InSAR: refine the orientation parameters of high-resolution stereo images or InSAR images by the technology of block adjustment or free net adjustment, the preliminarily refined orientation parameters are used for the subsequent steps;

Step 2. DSM generation with high-resolution stereo images or InSAR: uses the preliminarily refined orientation parameters to generate DSM with geographic coordinates by the dense matches of the high-resolution stereo images or by InSAR technology;

Step 3. Grouping laser altimetry data: The laser altimetry data is grouped by orbit. When the orbit is too long, the altimetry data of one orbit could be divided into several groups or into sections. Select datasets of each group and perform steps (4)-(10), which include two times of waveform matching, to realize the registration between laser spot and DSM, and to realize the extraction of system errors in DSM area where the laser spot is on;

Step 4. Preprocessing of received group waveforms: select the valid laser altimetry waveform data sets of each received group. Suppose there are N valid-waveforms in one received group after removing those invalid data. Correct the errors effected by instruments, troposphere, tides, atmosphere, etc. and carry out normalization processing for these N received waveforms;

Step 5. Observation design for simulation waveforms acquisitions: Take the locations of all theoretical laser spot centers of the received group as the center of grids, which are designed with same sizes and orientations, for matching search on DSM. In order to get simulation groups for matching with the received group, take the positions of each corresponding points on DSM grids as laser spot center to simulate waveforms. The parameters used for simulations have the same observation parameters as received waveforms, except for the altimetry attitudes. So that the simulated observation can observes all the designed DSM search areas; Specifically through steps 5.1-5.3:

5.1 Design of the search interval and search step size: According to the relative accuracy of the plane between the spot and the DSM and the DSM resolution, design the search numbers and step length of the simulation spot center through designing the size and interval of grids;

5.2 The selection of the simulated observation variation parameters: The DSM target is searched by designing the simulated laser altimetry observation orientation parameter change interval and step size. We can simultaneously change the observation attitudes of each station in the received group with the same increment, and keep other observation parameters of the received group as constant. So different locations of grid points on DSM could be used as observation centers for simulations;

5.3 Inverse calculation of simulated observation parameters: According to the location of grid point on DSM and the satellite location of the received waveform, calculate and configure the simulation parameters for observation. The sensor parameters used for simulation are consistent with those used for receiving waveform except pitch and roll of satellite attitudes;

Step 6. Acquisitions of simulation groups through simulation observation: DSM data near grid points are used to generate simulation waveforms. Group of simulation waveforms can be obtained by taking the position of corresponding grid points of all grids as the spot center of simulation. Suppose the number of received waveforms in the group is N and the number of grid points in per grid is M, that means the number of grids is N and the number of simulation groups is M.

Conduct space segmentation of spot area according to DSM resolution during simulated observation. Calculate the energy and distribution of each segmented unit according to the position and the size of segmentation unit in the spot area. Sub-echo energy and distribution reflected by resolvable unit of DSM corresponding to specific elevations are calculated by convolution operation. Accumulate all sub-echo energy at each sampling time to form simulation waveform; normalize all simulated waveforms for matching in subsequent steps;

Step 7. Matching the received group with simulation groups: normalize all waveforms of the received and simulated. Display all waveforms in X-Y coordinate system (X: Received time relative to start time of beam emission-Y: Waveform amplitude). take the received group waveforms as matching template and select the simulated observation group in turn. Move the received group waveforms as a whole along the time axis X, calculate and record the best matching measure value between the received group and the simulated group, and can get M values corresponding to simulation groups. Then complete the first time of waveform matching.

In this step matching measure of the received waveforms and simulation waveforms can be realized by taking the square sum of the distances between the corresponding points of the waveforms, or the template matching algorithm as matching measure, obtaining the measure value of the best match.

In this step, the overall system error of DSM elevation can be estimated and eliminated by the offset of the template waveforms moving along the time axis. If the DSM system error is small or negligible, the matching between the received group and the simulated groups can be omitted.

Step 8. Registration between laser spot position and DSM position: select the best one from the M matching measure values, and the corresponding simulation group is called the optimal simulation group, and the corresponding locations of grid points are the registration positions of DSM with the spot centers of received lasers. The registration positions could be considered as the actual location of the laser spot on the DSM. The plane offset between the registration position and the theoretical position calculated by the satellite sensor parameters is called as registration plane offset.

Step 9. Matching the received waveform and the corresponding waveform in optimal simulation group respectively: The time offset of the received waveforms and the simulated waveforms along the X-axis can be obtained by matching the pair of waveforms. This step includes the second time of waveform matching.

Step 10. Extraction of elevation errors and control points of local DSM in spot area: calculate the elevation system error of local DSM in spot area according to the time offset obtained in step (9). Select a 3D coordinates of one DSM point at the spot area and corrected by the local DSM system error, the 3D coordinates with corrected elevation value is considered as elevation control point of DSM;

Step 11. Extraction of elevation control points for remote sensing images: Translate the 3D coordinates without local DSM system error correction to image coordinates with geometric model using the preliminarily refined orientation parameters of stereo or InSAR images. The image point coordinates and the corrected elevation value are constitute image elevation control points, which could be used for image geometry processing and improving elevation accuracy;

Step 12. Geometric processing of remote sensing data: refine DSM products by fitting and interpolating the extracted elevation control points and their system errors, calibrate attitudes of laser altimeter sensor according to the registration plane offsets, improve 3D reconstruction accuracy of images with elevation control points of images, and realize further joint processing of remote sensing images and laser altimetry data.

The DSM products can be refined according to the local DSM elevation system errors, by fitting and interpolating the elevation errors of the DSM in the whole measurement area. 3D reconstruction accuracy or positioning accuracy can be improved by refining orientation parameters of stereo images and InSAR images, and orientation parameters can be refined by adjustment model with help of elevation control points, together with ground control points and tie points. The calibration of the laser altimeter sensor is using the plane offset between the theoretical position of the laser spot center and the registration position obtained in step (8) and the satellite altitude, to calculate corrections of attitudes or view direction of laser altimeter. Further joint processing of remote sensing image data and laser altimetry data can be realized by the elevation combined adjustment with the remote sensing data and laser altimetry data.

where in the step (7)-(10) two times of matching can also be converted into once as following: After grouping and simulated observation, each simulated observation group and received group are still taken as the processing objects. The received waveforms are matched with the corresponding waveforms in each simulation group respectively. When the best matching reaches, the best match measure values and the offsets along the time axis between the received and simulated waveform are recorded. Calculate the mean S₁ of the best match measure values of each simulation group, the time offset X_{off} between received waveforms and simulated waveforms, and the variance S₂ of the offsets in group. Select the simulated observation group which have the best mean S₁ and minimum S₂ as the optimal simulation group, or have a best weighted value of S₁ and S₂. The laser spot locations of optimal simulation group on DSM are the registration locations of the received laser spots. The system errors in DSM of optimal simulation spot area can be calculate by the time offsets X_{off} between received waveform and optimal simulation waveform. Elevation control points of DSM and elevation control points of images can be extracted as above. The waveform match technique of the laser altimetry data and the DSM simulated observation data provided by the invention has no relationship with the source data for generating the DSM. Therefore, it can be used not only for the spatial registration between location of observed object of laser altimetry and DSM generated by high resolution stereo images or InSAR, but also the spatial registration between the locations of observed objects and DSM or DEM generated by other methods or point cloud data. Obtain registration position of laser altimetry spot and DSM, DEM of the spot, or elevation local system error of point cloud data.

The waveform match technique of the laser altimetry can be used for not only single beam laser altimetry data, but also multi-beam laser altimetry data.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 illustrates the relations of forms and positions between the simulated group waves and the received group waves;

FIG. 2 illustrates the matching search process for registration between group laser spots and DSM;

FIG. 3 illustrates the extraction flow of elevation control points assisted by satellite laser altimetry data.

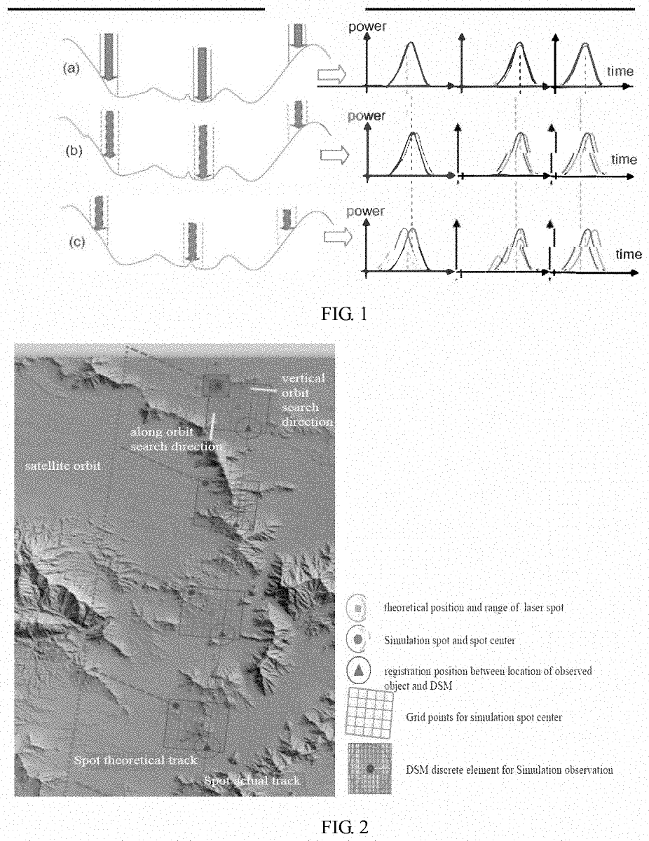

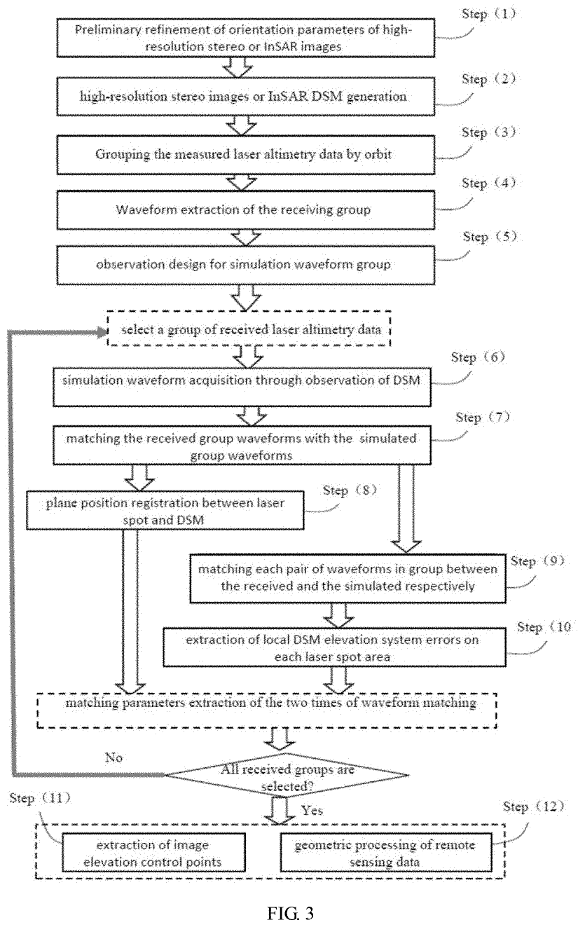

### DETAILED DESCRIPTION

A description of example embodiments follows.

An invention of elevation control point extraction assisted by satellite laser altimeter data, includes two times of waveform matching and joint processing of multi-source remote sensing data.

Step 1. Preliminary refinement of orientation parameters of high-resolution stereo images or InSAR: refine the orientation parameters of high-resolution stereo images or InSAR images by the technology of block adjustment or free net adjustment, the preliminarily refined orientation parameters are used for the subsequent steps;

Step 2. DSM generation with high-resolution stereo images or InSAR: uses the preliminarily refined orientation parameters to generate DSM with geographic coordinates by the dense matches of the high-resolution stereo images or by InSAR technology;

Step 3. Grouping laser altimetry data: The laser altimetry data in the range of the measurement area is grouped by orbit. When the orbit is too long, the altimetry data of one orbit could be divided into several groups or into sections. Select datasets of each group and perform steps (4)-(10), which include two times of waveform matching, to realize the registration between laser spot and DSM, and to realize the extraction of system errors in DSM area where the laser spot is on;

Step 4. Preprocessing of received group waveforms: select the valid laser altimetry waveform data sets of each received group. Suppose there are N valid-waveforms in one received group after removing those invalid data. Correct the errors effected by instruments, troposphere, tides, atmosphere, etc. and carry out normalization processing for these N received waveforms;

Step 5. Observation design for simulation waveforms acquisitions: Take the locations of all theoretical laser spot centers of the received group as the center of grids, which are designed with same sizes and orientations, for matching search on DSM. In order to get simulation groups for matching with the received group, take the positions of each corresponding points on DSM grids as laser spot center to simulate waveforms. The parameters used for simulations have the same observation parameters as received waveforms, except for the altimetry attitudes. so that the simulated observation can observes all the designed DSM search areas; Specifically through steps 5.1-5.3:

5.1 Design of the search interval and search step size: According to the relative accuracy of the plane between the spot and the DSM and the DSM resolution, design the search numbers and step length of the simulation spot center through designing the size and interval of grids;

5.2 The selection of the simulated observation variation parameters: The DSM target is searched by designing the simulated laser altimetry observation orientation parameter change interval and step size. We can simultaneously change the observation attitudes of each station in the received group with the same increment, and keep other observation parameters of the received group as constant. So different locations of grid points on DSM could be used as observation centers for simulations;

5.3 Inverse calculation of simulated observation parameters: According to the location of grid point on DSM and the satellite location of the received waveform, calculate and configure the simulation parameters for observation. The sensor parameters used for simulation are consistent with those used for receiving waveform except pitch and roll of satellite attitudes.

Roll and pitch of simulation observation attitudes calculated by the location of laser spot center, that is, the location of grid points on DSM.

Direction of beam center is same as the direction from satellite to grid point, which could be used for calculation of roll and pitch.

Different areas of DSM are searched and simulated by changing roll and pitch of the laser altimeter sensor, guided by different grid point in turn.

When the scheme of circular search range centered on the theoretical beam center is used, the simulated observation that search range exceeds the circle radius can be directly abandoned on the basis of rectangular search.

Step 6. Acquisitions of simulation groups through simulation observation: DSM data near grid points are used to generate simulation waveforms. Group of simulation waveforms can be obtained by taking the position of corresponding grid points of all grids as the spot center of simulation. Suppose the number of received waveforms in the group is N and the number of grid points in per grid is M, that means the number of grids is N and the number of simulation groups is M.

Conduct space segmentation of spot area according to DSM resolution during simulated observation. Calculate the energy and distribution of each segmented unit according to the position and the size of segmentation unit in the spot area. Sub-echo energy and distribution reflected by resolvable unit of DSM corresponding to specific elevations are calculated by convolution operation. Accumulate all sub-echo energy at each sampling time to form simulation waveform; normalize all simulated waveforms for matching in subsequent steps;

Step 7. Matching the received group with simulation groups: normalize all waveforms of the received and simulated. Display all waveforms in X-Y coordinate system (X: Received time relative to start time of beam emission-Y: Waveform amplitude). take the received group waveforms as matching template and select the simulated observation group in turn. Move the received group waveforms as a whole along the time axis X, calculate and record the best matching measure value between the received group and the simulated group, and can get M values corresponding to simulation groups. Then complete the first time of waveform matching.

In this step matching measure of the received waveforms and simulation waveforms can be realized by taking the square sum of the distances between the corresponding points of the waveforms, or the template matching algorithm as matching measure, obtaining the measure value of the best match.

In this step, the overall system error of DSM elevation can be estimated and eliminated by the offset of the template waveforms moving along the time axis. If the DSM system error is small or negligible, the matching between the received group and the simulated groups can be omitted;

Step 8. Registration between laser spot position and DSM position: select the best one from the M matching measure values, and the corresponding simulation group is called the optimal simulation group, and the corresponding locations of grid points are the registration positions of DSM with the spot centers of received lasers. The registration positions could be considered as the actual location of the laser spot on the DSM. The plane offset between the registration position and the theoretical position calculated by the satellite sensor parameters is called as registration plane offset.

Step 9. Matching the received waveform and the corresponding waveform in optimal simulation group respectively: The time offset of the received waveforms and the simulated waveforms along the X-axis can be obtained by matching the pair of waveforms. This step includes the second time of waveform matching.

Step 10. Extraction of elevation errors and control points of local DSM in spot area: calculate the elevation system error of local DSM in spot area according to the time offset obtained in step (9). Select a 3D coordinates of one DSM point at the spot area and corrected by the local DSM system error, the 3D coordinates with corrected elevation value is considered as elevation control point of DSM;

Step 11. Extraction of elevation control points for remote sensing images: Translate the 3D coordinates without local DSM system error correction to image coordinates with geometric model using the preliminarily refined orientation parameters of stereo or InSAR images. The image point coordinates and the corrected elevation value are constitute image elevation control points, which could be used for image geometry processing and improving elevation accuracy;

Step 12. Geometric processing of remote sensing data: refine DSM products by fitting and interpolating the extracted elevation control points and their system errors, calibrate attitudes of laser altimeter sensor according to the registration plane offsets, improve 3D reconstruction accuracy of images with elevation control points of images, and realize further joint processing of remote sensing images and laser altimetry data.

the DSM products can be refined according to the local DSM elevation system errors, by fitting and interpolating the elevation errors of the DSM in the whole measurement area. 3D reconstruction accuracy or positioning accuracy can be improved by refining orientation parameters of stereo images and InSAR images, and orientation parameters can be refined by adjustment model with help of elevation control points, together with ground control points and tie points. The calibration of the laser altimeter sensor is using the plane offset between the theoretical position of the laser spot center and the registration position obtained in step (8) and the satellite altitude, to calculate corrections of attitudes or view direction of laser altimeter. Further joint processing of remote sensing image data and laser altimetry data can be realized by the elevation combined adjustment with the remote sensing data and laser altimetry data.

where in the step (7)-(10) two times of matching can also be converted into once as following: After grouping and simulated observation, each simulated observation group and received group are still taken as the processing objects. The received waveforms are matched with the corresponding waveforms in each simulation group respectively. When the best matching reaches, the best match measure values and the offsets along the time axis between the received and simulated waveform are recorded. Calculate the mean S₁ of the best match measure values of each simulation group, the time offset X_{off} between received waveforms and simulated waveforms, and the variance S₂ of the offsets in group. Select the simulated observation group which have the best mean S₁ and minimum S₂ as the optimal simulation group, or have a best weighted value of S₁ and S₂. The laser spot locations of optimal simulation group on DSM are the registration locations of the received laser spots. The system errors in DSM of optimal simulation spot area can be calculate by the time offsets X_{off} between received waveform and optimal simulation waveform. Elevation control points of DSM and elevation control points of images can be extracted as above. The waveform match technique of the laser altimetry data and the DSM simulated observation data provided by the invention has no relationship with the source data for generating the DSM. Therefore, it can be used not only for the spatial registration between laser altimetry target and DSM generated by high resolution stereo images or InSAR, but also the spatial registration between the laser altimetry target and DSM, DEM generated by other methods or point cloud data. Obtain registration position of laser altimetry spot and DSM, DEM of the spot, or elevation local system error of point cloud data.

The waveform match technique of the laser altimetry can be used for not only single beam laser altimetry data, but also multi-beam laser altimetry data.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A method of elevation control points extraction assisted by satellite laser altimeter data, using the measured laser altimetry waveform and the DSM simulated laser altimetry waveform group matching technology to realize planar position registration of spot area and DSM, elevation control points extraction and remote sensing geometric information processing, including the following steps:
(1) Preliminary refinement of orientation parameters of high-resolution stereo images or InSAR: refine the orientation parameters of high-resolution stereo images or InSAR data by the technology of block adjustment or free net adjustment, the preliminarily refined orientation parameters are used for the subsequent steps;
(2) DSM generation with high-resolution stereo images or InSAR: use the preliminarily refined orientation parameters to generate DSM with geographic coordinates by the dense matches of the high-resolution stereo images or by InSAR technology;
(3) Divising laser altimetry data into group: the laser altimetry data in the range of the measurement area is grouped by orbit;
when the orbit is too long, the altimetry data of one orbit could be divided into several groups or into sections; and
select datasets of each group and perform steps (4)-(10), which include two times of waveform matching, to realize the registration between laser spot and DSM, and to realize the extraction of system errors in DSM area where the laser spot is on.
(4) Preprocessing of received group waveforms: select the valid laser altimetry waveform data sets of each received group;
suppose there are N valid-waveforms in one received group after removing those invalid data; and
correct the errors effected by instruments, troposphere, tides, atmosphere, etc. and carry out normalization processing for these N received waveforms;
(5) Observation design for simulation waveforms acquisitions: take the locations of all theoretical laser spot centers of the received group as the center of grids, which are designed with same sizes and orientations, for matching search on DSM;
in order to get simulation groups for matching with the received group, take the positions of each corresponding points on DSM grids as laser spot center to simulate waveforms; and
the parameters used for simulations have the same observation parameters as received waveforms, except for the altimetry attitudes.
(6) Acquisitions of simulation groups through simulation observation: DSM data near grid points are used to generate simulation waveforms;
group of simulation waveforms can be obtained by taking the position of corresponding grid points of all grids as the spot center of simulation; and
suppose the number of received waveforms in the group is N and the number of grid points in per grid is M, that means the number of grids is N and the number of simulation groups is M.
(7) Matching the received group with simulation groups: normalize all waveforms of the received and simulated;
display all waveforms in X-Y coordinate system (X: Received time relative to start time of beam emission-Y: Waveform amplitude);
take the received group waveforms as matching template and select the simulated observation group in turn. Move the received group waveforms as a whole along the time axis X, calculate and record the best matching value between the received group and the simulated group, and can get M values corresponding to simulation groups;
(8) Registration between laser spot position and DSM position: select the best one from the M matching measure values, and the corresponding simulation group is called the optimal simulation group, and the corresponding locations of grid points are the registration positions of DSM with the spot centers of received lasers;
the registration positions could be considered as the actual location of the laser spot on the DSM; and
the plane offset between the registration position and the theoretical position calculated by the satellite sensor parameters is called as registration plane offset.
(9) Matching the received waveform and the corresponding waveform in optimal simulation group respectively: the time offset of the received waveforms and the simulated waveforms along the X-axis can be obtained by matching the pair of waveforms.
(10) Extraction of elevation errors and control point of local DSM in spot area: calculate the elevation system error of local DSM in spot area according to the time offset obtained in step (9); and
select a 3D coordinates of one DSM point at the spot area and corrected by the local DSM system error, the 3D coordinates with corrected elevation value is considered as elevation control point of DSM.
(11) Extraction of elevation control points for remote sensing images:
translate the 3D coordinates without local DSM system error correction to image coordinates with geometric model using the preliminarily refined orientation parameters of stereo or InSAR images; and
the image point coordinates and the corrected elevation value are constitute image elevation control points, which could be used for image geometry processing and improving elevation accuracy.
(12) Geometric processing of remote sensing data: refine DSM products by fitting and interpolating the extracted elevation control points and their system errors, calibrate attitudes of laser altimeter sensor according to the registration plane offsets, improve 3D reconstruction accuracy of images with elevation control points of images, and realize further joint processing of remote sensing images and laser altimetry data.

2. The method of elevation control point extraction assisted by satellite laser altimeter data according to claim 1, where in the step (7) matching measure of the received waveforms and simulation waveforms can take the square sum of the distances between the corresponding points of the waveforms, or the template matching algorithm as matching measure, calculating the measure value of the best match.

3. The method of elevation control point extraction assisted by satellite laser altimeter data according to claim 1, where in the steps (7)-(10) two times of matching can also be converted into once as following: after simulation, each simulated observation group and received group are still taken as the processing objects. The received waveforms are matched with the corresponding waveforms in each simulation group respectively;
when the best matching reaches, the best match measure values and the offsets along the time axis between the received and simulated waveform are recorded;
calculate the mean S₁ of the best match measure values of each simulation group, the time offset X_{off} between received waveforms and simulated waveforms, and the variance S₂ of the offsets in group;
select the simulated observation group which have the best mean S₁ and minimum S₂ as the optimal simulation group, or have a best weighted value of S₁ and S₂;
the laser spot locations of optimal simulation group on DSM are the registration locations of the received laser spots;
the system errors in DSM of optimal simulation spot area can be calculate by the time offsets X_{off} between received waveform and optimal simulation waveform; and
elevation control points of DSM and elevation control points of images can be extracted as above.

4. The method of elevation control point extraction assisted by satellite laser altimeter data according to claim 1, where in the step (12) the DSM products can be refined according to the local DSM elevation system errors, by fitting and interpolating the elevation errors of the DSM in the whole measurement area;
3D reconstruction accuracy or positioning accuracy can be improved by refining orientation parameters of stereo images and InSAR images, and orientation parameters can be refined by adjustment model with help of elevation control points, together with ground control points and tie points.

5. The method of elevation control point extraction assisted by satellite laser altimeter data according to claim 1, where in the step (12) the calibration of the laser altimeter sensor is using the plane offset between the theoretical position of the laser spot center and the registration position obtained in step (8) and the satellite altitude, to calculate corrections of attitudes or view direction of laser altimeter.

6. The method of elevation control point extraction assisted by satellite laser altimeter data according to claim 1, where in the step (12) further joint processing of remote sensing image data and laser altimetry data can be realized by the elevation combined adjustment with the remote sensing data and laser altimetry data.

7. The method of elevation control point extraction assisted by satellite laser altimeter data according to claim 1, where the DSM used for registration not only include those generated by high resolution stereo images or InSAR, but also include those DSM or digital elevation mode (DEM) generated by other methods or point cloud data; and so the registration of laser spots and other DSM/DEM and their system errors in spot area also can be easily calculated.

8. The method of elevation control point extraction assisted by satellite laser altimeter data according to claim 1, where in the waveform match technique of the laser altimetry can be used for not only single beam laser altimetry data, but also multi-beam laser altimetry data.
